(19) United States
(12) Patent Application Publication
(10) Pub. No.: US 2008/0061940 A1
(43) Pub. Date: Mar. 13, 2008

(54) Smart antenna system for reading data tags

(75) Inventors: John Christian Onderko, Appleton, WI (US); Michael Donald O'Shea, Neenah, WI (US)

Correspondence Address: KIMBERLY-CLARK WORLDWIDE, INC.;Catherine E. Wolf, 401 NORTH LAKE STREET, NEENAH, WI, 54956, US

(73) Assignee: Kimberly-Clark Worldwide, Inc.

(21) Appl. No.: 11/498,865

(22) Filed: Aug. 3, 2006

(51) Int. Cl. H04Q 5/22

(52) U.S. Cl. 340/10.1; 340/572.1; 710/11; 340/572.4; 235/376

(57) ABSTRACT

A method and apparatus can provide system (20) for reading radio frequency identification tags (22). The system includes one or more individual readers (24), and each individual reader has an operative power supply (26), antenna (28), and communication system (30) for relaying data from the individual reader to an electronic data collection and management system (32). A computerized electronic processor (34) is separately and remotely located from the readers, and implements a programming of protocols for each antenna and reader. In a particular aspect, the electronic processor can provide digital signal processor logic and protocol code to each reader.

### TECHNICAL FIELD

The present invention relates to the field of article identification and tracking. In particular configurations, the invention relates to a system for reading data tags.

### BACKGROUND OF THE INVENTION

Data tag technology such as radio frequency identification (RFID) technology has employed passive smart tags (miniature antenna-containing tags requiring no internal power supply) that may be embedded in or attached to a product or material to convey information that may be read by a scanner. Generally, conductive or passive smart tags include a data circuit and an antenna. In particular, smart tags include a semiconductor, a coiled, etched, or stamped antenna, a capacitor, and a substrate on which the components are mounted or embedded. A protective covering is typically used to encapsulate and seal the substrate. Other data tags have been configured to be active or semi-passive.

In general, RFID systems and other data tag systems include readers and tags in which the tags generate an electromagnetic response to an electronic signal from a reader. The response signal is read by the reader, typically with a readable range on the order of a few feet, though broader or narrower ranges are possible. The signal generated by the tag includes information (e.g., an electronic product code) that identifies the tag or the article comprising the tag.

In current RFID systems, a reader comprises a power supply, an antenna, a circuit board and microchips providing on-board programming of the antenna and reader protocols, and a communication system to relay obtained information to a network or computer. The reader component has been relatively costly, and has exhibited the disadvantages of limited deployment in small confines and/or mobile-mounted applications due to size and power use requirements.

Accordingly, there has been a continued need for techniques and devices for reading data tags that can provide a more flexible system for reading data tags that can be more readily updated or upgraded at lower cost.

### BRIEF DESCRIPTION OF THE INVENTION

A method and apparatus can provide a system for reading radio frequency identification tags. The system includes at least one individual reader, and each individual reader has an operative power supply, antenna, and communication system for relaying data from the individual reader to an electronic data collection and management system. A computerized electronic processor is separately and remotely located from the readers, and implements a programming of protocols for the antenna and reader. In a particular aspect, the electronic processor can provide digital signal processor logic and protocol code to each reader. In other aspects, the system can include a plurality of individual readers and a plurality of individual antennas.

The method and apparatus can provide a less costly and more flexible system for reading data tags. For example, individual antennas can include fewer components and can be part of a wired and/or wireless network. Such antennas can be substantially less expensive than conventional RFID antennas and can be more easily configured or reconfigured for various desired purposes.

### BRIEF DESCRIPTION OF THE DRAWINGS

The method and apparatus will be better understood by reference to the following description of the method and apparatus taken in conjunction with the accompanying drawings, wherein:

FIG. 1 is an exemplary block diagram which illustrates a representative method and apparatus that provides a system for reading radio frequency identification tags.

### DETAILED DESCRIPTION OF THE METHOD AND APPARATUS

When introducing elements of the present method and apparatus or the particular configurations thereof, the articles “a,” “an,” “the,” and “said” are intended to mean that there are one or more of the elements. The terms “comprising,” “including,” and “having” are intended to be inclusive and mean that there may be additional elements other than the listed elements. Accordingly, the terms “comprises”, “comprising” and other derivatives from the root term “comprise” are intended to be open-ended terms that specify the presence of any stated features, elements, integers, steps, or components, and are not intended to preclude the presence or addition of one or more other features, elements, integers, steps, components, or groups thereof.

A data tag, smart tag, or other identification means (e.g., a bar code) may be placed by hand or by machinery on an article. The data tag may be placed inside or outside of the article. The data tag stores identification information. In one aspect, the information in the tag can be used to assist in the routing of the article in the manufacturing process. The data tag reader interrogates a data tag affixed to an article. The method and apparatus is operable with any form of data tag including, but not limited to, a smart tag and an active, semi-passive, or passive radio frequency identification (RFID) tag or the like, as well as combinations thereof.

RFID smart tag technology is known and understood by those skilled in the art, and a detailed explanation thereof is not necessary for purposes of describing aspects of the present method and apparatus. RFID systems for improved manufacturing have been proposed for systems including the PIPE/STORM systems disclosed in commonly owned U.S. patent application Ser. No. 10/306,794, “Communication Between Machines and Feed-Forward Control in Event-Based Product Manufacturing,” filed Nov. 27, 2002 (U.S. Patent Application Publication 2003/0155415; dated Aug. 21, 2003) by Markham et al., which is incorporated herein by reference in a manner that is consistent (noncontradictory) herewith.

In general, RFID chips may be read-only chips, which include a fixed electronic code, or they may be read-write chips, which allow an updating of prior information or an addition of new information. The chips may also be associated with sensors to read detected information and transmit a signal responsive to the detected information, such as a value detected from a biosensor. Exemplary smart tags that include RFID technology associated with a sensor are the active labels that are commercially available from KSW Microtec (Dresden, Germany). For example, TEMPSENS active smart labels can measure and record temperature.

RFID tags can take many physical formats, such as a microchip from 30 to 100 microns thick and from 0.1 to 1 mm across, joined to a minute metal antenna such as the Hitachi 2.45 GHz Mew chip. Another form is the “Coil-on-Chip” system from Maxell (Tokyo, Japan). Exemplary RFID vendors of tags and/or readers and associated systems include Intermec Technologies Corporation (Everett, Wash.), Symbol Technologies (Holtsville, N.Y.), Applied Wireless Identifications, Inc. (AWID) (Monsey, N.Y.), Philips Semiconductor (Eindhoven, The Netherlands), and Texas Instruments (Dallas, Tex.).

Readers may also be integrated into or added onto a laptop, a personal data assistant (PDA) device, a cellular telephone, or other electronic device. Readers for use in the present method and apparatus may include any known variety, including multi-protocol readers (e.g., those of Applied Wireless Identifications, Inc.) that scan multiple frequencies or that are adapted for reading a variety of RFID tags or other identification elements. Data tag readers may also be adaptive readers that adjust their scanning frequency, signal strength, and/or signal orientation or direction to improve the signal obtained from the tag or tags being read. Readers that can adapt their frequency are discussed, by way of illustration, in U.S. Pat. No. 6,765,476, “Multi-level RF Identification System,” issued Jul. 20, 2004 to Steele, herein incorporated by reference in a manner that is noncontradictory herewith.

The method and apparatus of the present disclosure may include a portal unit through which articles can pass and be subjected to scanning or interrogation. The portal unit can include one or more data tag readers (e.g., scanners, transponders, interrogators, or antenna systems). For example, RFID portals for forklifts, pallets, and other loads are well known, such as the portals of Pelican Control Systems Ltd. (England) and that of U.S. Patent Publication 20020104013, “Electronic Vehicle Product and Personal Monitoring.” Examples of other RFID portals include the LEADS-TRAKKER portal for reading RFID tags on humans, such as guests at conventions wearing RFID-enable passes. Automated tollbooths using RFID scanners are also another form of portal within the scope of the present method and apparatus.

The method and apparatus may also include self-adjusting portals, in which the physical location of readers in an individual portal are adjusted to optimize the read of an approaching load. Examples of such portals are described in U.S. patent application Ser. No. 10/976,993 entitled “SELF-ADJUSTING PORTALS WITH MOVABLE DATA TAG READERS FOR IMPROVED READING OF DATA TAGS” by John Onderko et al. and filed Oct. 29, 2004 (attorney docket No. 20,594); the entire disclosure of which is incorporated herein by reference in a manner that is consistent herewith.

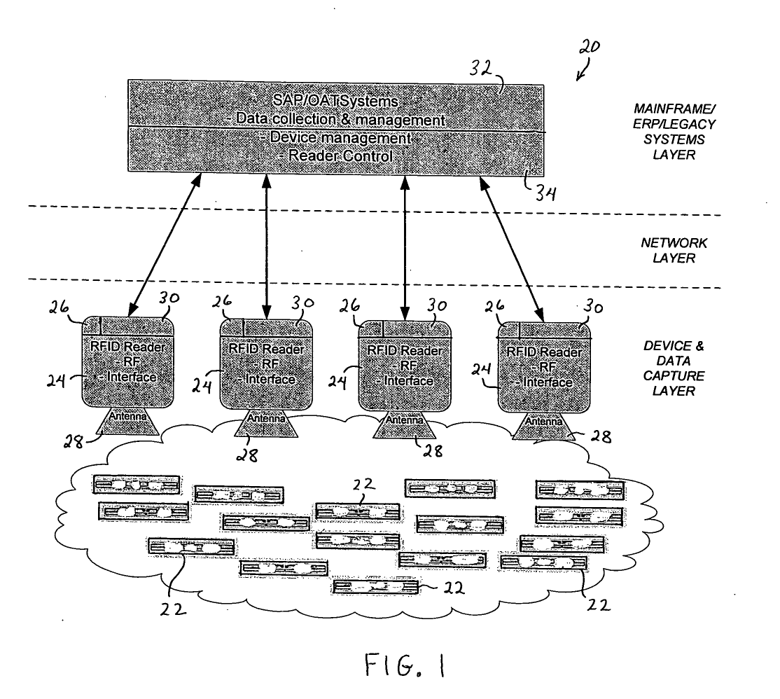

Referring to FIG. 1, an exemplary block diagram illustrates a representative method and apparatus which can provide a system 20 for reading radio frequency identification tags 22. The system includes at least one individual reader 24, and each individual reader has an operative power supply 26, at least one antenna 28, and communication system 30 for relaying data from the individual reader to an electronic data collection and management system 32. A computerized electronic processor 34 is separately and remotely located from the readers, and implements a programming of protocols for each reader 24 and its corresponding antenna or antennas 28. In a particular aspect, the electronic processor can provide needed digital signal processor (DSP) logic and protocol code to each individual reader. In other aspects, the system can include a plurality of two or more individual readers 24, and can include a plurality of individual antennas. In further aspects, the system 20 can provide large antenna populations which can be remotely managed. In desired arrangements, the antenna populations can be remotely managed with an computerized electronic processor 34, and/or an electronic data collection and management system 32.

The distinctive method and apparatus of the present disclosure can provide a less costly and more flexible system by offloading the logic board and optionally the power supply from the reader to a remote system, and configuring the antenna or antennas to be part of a wired and/or wireless network. Such antennas can be substantially less expensive than conventional RFID antennas and can be more easily configured for various purposes.

The system 20 can operatively interrogate and read information or data from radio frequency identification tags, and includes at least one individual skeleton reader 24. In particular configurations, the system may include a selected plurality of two or more individual skeleton readers.

Each individual reader 24 can have an operative power supply 26, and at least one antenna 28. Optionally, the individual reader may include an antenna group or set having a plurality of individual antennas 28. Multiple antennas can, for example, help the reader interrogate and receive data from a diverse selection of a plurality of tags where the individual tags have been configured to operate in different, widely-spaced frequencies or frequency bands, such as low-frequency (LF), high-frequency (HF), very-high frequency (VHF), ultra-high frequency (UHF) and super-high frequency (SHF). The operational radio-frequency of the various components of the method and apparatus 20 (e.g. readers, antennas, communication systems) can be as low as about 100 KHz (kilo-Hertz, and can be up to about 6 GHz (Giga-Hertz), or more.

In a particular configuration, the reader 24 and/or the antenna 28 may be powered by a Power-Over-Ethernet (POE) system. Examples of suitable POE systems are described in IEEE Standard 802.3af.

Alternatively, the reader and/or antenna may be powered by conventional techniques and devices. Such techniques and devices can, for example, include capacitors, batteries, photo-voltaic cells, electrically-wired power supplies or the like, as well as combinations thereof.

The individual reader 24 may, for example, be configured to include photo-electric sensors, temperature sensors, atmospheric pressure sensors, accelerometers, a LAN/PAN network switching and/or hub functionality, a wired and/or wireless LAN/PAN functionality, other Digital Input/Output multi-state sensors, or the like, as well as combinations thereof. The individual reader 24 can also be configured to provide temperature and/or pressure monitoring, shock and vibration input or the like.

The individual antenna or antenna set 28 may include other operative components. For example, the individual antenna or antenna set may be configured to include photo-electric sensors, proximity sensors, LED lights for visual identification of reader operations or the like, as well as combinations thereof.

In some configurations of the method and apparatus, selected amounts and selected types of logic may be programmed into the antenna system. For example, one or more individual antennas may be programmed with one or more EPC (electronic product code) global protocols, automatic activation and shut-off mechanisms, adjustable/varying power levels, a selection of broadcasting frequencies per differing regulatory environments or the like, as well as combinations thereof. An individual antenna 28 can also be configured to provide one or more of the following functions: RFID transponder reading/encoding, WI-FI access point, and/or other wireless data transmissions.

The communication system 30 can be configured to operatively relay data from the individual reader to an electronic data collection and management system 32. The communication system can be wired, wireless or a combination thereof. Examples of suitable communication systems can include one or more of the following techniques or devices: IEEE 802.11 (WI-FI standard), IEEE 802.3 (wired standard), IEEE 802.15 (PAN standard). The communication system 30 can also be configured to provide network emulation, device/group management, individual stand-alone operation or the like, as well as combinations thereof.

The electronic data collection and management system 32 can, for example, include a computer network or a computerized database. Other electronic data collection and management systems can also be provided.

The computerized electronic processor 34 is separately and remotely located from the readers, and can be operatively configured to implement a programming of protocols for each employed antenna 28 and reader 24. For example, the computerized electronic processor can include a computer server. In particular configurations, the computerized processor 34 can be remotely located from the readers by a distance of several meters or more.

In a particular aspect of the system 20, the electronic processor 34 can provide at least a significant portion of the digital signal processor (DSP) logic and/or protocol code needed by the individual readers 24. In a particular aspect, the electronic processor 34 can provide at least about 20% of the digital signal processor logic and/or protocol code needed by the readers. The electronic processor 34 can alternatively provide at least about 50%, and can optionally provide at least about 60% of the digital signal processor logic and/or protocol code needed by the readers 24. In other aspects, the electronic processor 34 can provide up to about 90% or 100% of the digital signal processor logic and/or protocol code needed by the readers.

The digital signal processor logic can include corresponding hardware, firmware and/or software, and can include any type of DSP logic. The protocol code can be provided for by corresponding hardware, firmware and/or software, and can include at least code for the Transmission Control Protocol (TCP), and code for the Internet Protocol (IP). Additionally, the protocol code can include any other type of protocol code.

In a desired feature, the computerized electronic processor 34 (e.g. a central server) can provide the digital signal processor (DSP) logic and protocol code, in a manner which allows the antenna to act as a network peripheral device. The signals received by the antenna from readings (e.g. from backscatter readings) of RFID tags can be sent to the server or other electronic processor 34 over an operative communication link, such as a wired or wireless network, and the signals can be analyzed, interpreted and processed by the server or other electronic processor 34. The electronic processor can thus be configured to operate as a virtual RFID reader. The electronic processor 34 (e.g. server) may be programmed or otherwise configured to include the electronic data collection and management system 32. Alternatively, the electronic processor 34 may be otherwise operatively connected or linked to the electronic data collection and management system 32. For example, the electronic processor 34 can be operatively coordinated with cooperating, warehouse management-system logic, or may be operatively integrated with any other software system. Such software systems can, for example, include Enterprise Resource Planning (ERP) systems, or the like.

The system 20 may operatively connect multiple “smart” antennas 28 to an individual computerized electronic processor 34 (e.g. computer server). In particular arrangements, for example, each antenna may be remotely activated for a period of time to provide readings without interference from the other antennas so networked. In another arrangement, the communication between the server and multiple antennas may incorporate the principles of the smart shelf system of MeadWestvaco Intelligent Systems (now Vue Technologies), in which a single reader communicates with multiple antennas using systems analogous to computer network communications protocols. Such a system is described in WO2003061060A2 of MeadWestvaco Intelligent Systems (now Vue Technology).

In further configurations of the system 20, some degree of logic may still be programmed into the antenna. In particular arrangements, the power delivered to the antennas by the network can be responsive to feed-forward information provided by other devices that may scan a code on a pallet, for example, and the scanned code can provide information about the optimum reader power for reading data tags associated with individual items on the pallet.

In the various configurations of the system 20, the offloading of the logic board, and optionally the power supply 26, from the reader 24 to a remote electronic processor system 34, and the configuring of the antenna or antennas 28 to be part of a wireless network can help provide distinctive advantages. Such advantages may include, for example, simpler infrastructure development and deployment, and lower installation costs.

Additionally, the offloading of the logic board, and optionally the power supply 26, from the reader 24 to a remote electronic processor system 34, and the configuring of the antenna or antennas 28 to be part of a wireless network can help enable the efficient conduct or execution of desired tasks or operations. Such tasks may, for example, include a more rapid infrastructure deployment and a more rapid installation of hardware associated with the system.

Information from the electronic data collection and management system 32, such as information provided by logistics systems, SAP systems, electronic data interchange (EDI) systems or bill of lading (BOL) systems, can be used to expedite business transactions. In another aspect, the information may be received or obtained from a feed-forward process control system (see, for example, U.S. Patent Publication No. U.S.20030155415-A1, “Communication between Machines and Feed-Forward Control in Event-Based Product Manufacturing,” published Aug. 21, 2003 by Markham et al., previously incorporated by reference herein).

RFID may be applied in various ways to determine the location of the article 102. This can be done, for example, using triangulation involving a plurality of RFID readers that read the tag, or with directional readers that scan for the location of a tag. See, for example, J. Lindsay, “RETAIL RFID SYSTEMS WITHOUT SMART SHELVES,” published at IP.com as Document 21114D, Dec. 23, 2003, herein incorporated by reference. A directional reader with a directional and optionally moveable antenna or antenna array adapted to determine the approximate location of an RFID tag may be mounted on or near the positioning device 106, or remote therefrom, or may be the data tag reader 104 itself of FIG. 1. One example of a reader system adapted for determining the spatial location of a tag is taught by D. G. Bauer et al. in “INTELLIGENT STATION USING MULTIPLE RF ANTENNAE AND INVENTORY CONTROL SYSTEM AND METHOD INCORPORATING THE SAME,” U.S. Patent Publication 200030174099-A1, published Sep. 18, 2003, filed as U.S. patent application Ser. No. 10/338,892, assigned to MeadWestvaco Corporation, herein incorporated by reference in a manner that is noncontradictory herewith. Another approach is described in U.S. Pat. No. 6,750,769, “METHOD AND APPARATUS FOR USING RFID TAGS TO DETERMINE THE POSITION OF AN OBJECT,” issued Jun. 15, 2004 to R. B. Smith, herein incorporated by reference in a manner that is noncontradictory herewith. The system described in U.S. Pat. No. 6,750,769 employs an array of RFID tags, some of which are obscured relative to a reader by the presence of an intervening object. Analysis of the obscured and non-obscured signals provides spatial information about the object.

The method and apparatus is operable with any form of computer or computing device known in the art. A user may enter commands and information into the computing device through input devices or user interface selection devices well known in the art such as a keyboard and a pointing device (e.g., a mouse, trackball, pen, or touch pad). The computer typically has at least some form of computer readable media. Computer readable media, which include volatile and nonvolatile media, removable and non-removable media, may include any available medium that may be accessed by a computer. By way of example and not limitation, computer readable media comprise computer storage media and communication media. Computer storage media include volatile and nonvolatile, removable and non-removable media implemented in any method or technology for storage of information such as computer readable instructions, data structures, program modules or other data. For example, computer storage media include RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium that may be used to store the desired information and that may be accessed by the computer. Communication media typically embody computer readable instructions, data structures, program modules, or other data in a modulated data signal such as a carrier wave or other transport mechanism and include any information delivery media. Those skilled in the art are familiar with the modulated data signal, which has one or more of its characteristics set or changed in such a manner as to encode information in the signal. Wired media, such as a wired network or direct-wired connection; and wireless media, such as acoustic, RF, infrared, and other wireless media; are examples of communication media. Combinations of any of the above are also included within the scope of computer readable media. The method and apparatus also includes the computing device itself when programmed and configured in accordance with the methods and techniques described in the present disclosure.

The method and apparatus may be described in the general context of computer-executable instructions, such as program modules, executed by one or more computers or other operative devices. Generally, program modules can include, but are not limited to, routines, programs, objects, components, and data structures that perform particular tasks or implement particular abstract data types. The method and apparatus may also be practiced in distributed computing environments where tasks are performed by remote processing devices that are linked through a communications network. In a distributed computing environment, program modules may be located in both local and remote computer storage media including memory storage devices.

A related technology within the scope of the present method and apparatus is Surface Acoustic Wave (SAW) technology. For example, InfoRay (Cambridge, Mass.) markets a passive smart tag that is said to achieve long ranges (up to 30 meters) using a Surface Acoustic Wave (SAW) device on a chip coupled with an antenna. The SAW device converts a radio signal to an acoustic wave, modulates it with an identification code, then transforms it to another radio signal that is emitted by the smart tag and read by a scanner or other reader. The identification code of the smart tag is extracted from the radio signal. RFSAW, Inc. (Dallas, Tex.) also provides highly miniaturized, Surface Acoustic Wave (SAW) RFID devices that may be used within the scope of the present method and apparatus.

Another related technology is ultra-wide band (UWB) technology. UWB technology permits wireless communication between objects using low-power electromagnetic transmissions. However, the receivers and transmitters generally are both active, but use very low power, typically less than that of radio frequency noise, relying on transmissions of intermittent pulses over a broad band of frequencies rather than transmissions limited to a particular frequency. UWB technology may provide much higher spatial capacity (information transmission per unit area) than other wireless standards such as BLUETOOTH brand computer communication services, or Institute of Electronics and Electrical Engineering (IEEE) 802.11a or 802.11b communication systems.

The order of execution or performance of the representative techniques or methods illustrated and described in the present disclosure is not essential, unless otherwise specified. That is, the elements of the techniques or methods may be performed in any order, unless otherwise specified, and the techniques or methods may include more or less elements than those disclosed herein. For example, it is contemplated that an executing or performing of a particular element before, contemporaneously with, or after another element are all within the scope of the method and apparatus.

Those skilled in the art will recognize that the present method, apparatus or system is capable of many modifications and variations without departing from the scope thereof. Accordingly, the detailed description and examples set forth above are meant to be illustrative only and are not intended to limit, in any manner, the scope of the method and apparatus as set forth in the appended claims.

1. A system for reading radio frequency identification tags, the system comprising:
at least one individual reader, the individual reader having an operative power supply, antenna, and communication system for relaying data from the individual reader to an electronic data collection and management system;
a computerized electronic processor which is separate and remotely located from the readers, and implements a programming of protocols for each antenna and reader;
wherein
the electronic processor provides a significant portion of the digital signal processor logic and protocol code needed by each reader;

2. A system as recited in claim 1, wherein the electronic processor provides at least about 50% of the digital signal processor logic and protocol code needed by the reader.

3. A system as recited in claim 2, wherein the electronic processor provides up to about 100% of the digital signal processor logic and protocol code needed by the reader.

4. A system as recited in claim 2, wherein the protocol code includes at least the code for Transmission Control Protocol, and the code for Internet Protocol.

5. A system as recited in claim 1, wherein the reader has a plurality of individual antennas configured to interrogate and receive data from tags, and the tags have been configured to operate in different, widely-spaced frequencies or frequency bands.

6. A system as recited in claim 5, wherein one or more individual antennas have been programmed with one or more electronic product code protocols.

7. A system as recited in claim 1, wherein
the system includes a plurality of individual readers; and
each individual reader has an operative power supply, antenna, and communication system for relaying data from the individual reader to the electronic data collection and management system.

8. A system as recited in claim 7, wherein the electronic processor provides at least about 50% of the digital signal processor logic and protocol code needed by the readers.

9. A system as recited in claim 8, wherein the electronic processor provides up to about 100% of the digital signal processor logic and protocol code needed by the reader.

10. A system as recited in claim 9, wherein the protocol code includes at least code for the Transmission Control Protocol and Internet Protocol.

11. A system as recited in claim 10, wherein the individual reader has a plurality of individual antennas configured to interrogate and receive data from tags, and the tags have been configured to operate in different, widely-spaced frequencies or frequency bands.

12. A system as recited in claim 11, wherein one or more individual antenna have been programmed with one or more electronic product code protocols.
